(19) United States
(12) Patent Application Publication
(10) Pub. No.: US 2010/0100445 A1
(43) Pub. Date: Apr. 22, 2010

(54) SYSTEM AND METHOD FOR TARGETING THE DELIVERY OF INVENTORIED CONTENT OVER MOBILE NETWORKS TO UNIQUELY IDENTIFIED USERS

(75) Inventors: Donald Flood, San Francisco, CA (US); Mark Schaaf, San Francisco, CA (US); Venkatsh Karnam, Sunnyvale, CA (US); Edward Kessler, Los Gatos, CA (US)

Correspondence Address: PERKINS COIE LLP, P.O. BOX 1208, SEATTLE, WA, 98111-1208, US

(73) Assignee: AdMob, Inc., San Mateo, CA (US)

(21) Appl. No.: 12/246,441

(22) Filed: Oct. 6, 2008

Related U.S. Application Data
(60) Provisional application No. 60/998,043, filed on Oct. 5, 2007.

(51) Int. Cl. G06Q 30/00; G06F 17/30; G06F 15/16

(52) U.S. Cl. 705/14.64; 705/14.49; 707/802; 707/E17.045; 709/223

(57) ABSTRACT

A method and system for targeting online advertisements. The method includes receiving a request for an advertisement from a publisher, wherein the request includes an identifying data uniquely associated with a user. The method includes sending a response to the publisher, wherein the response includes the advertisement and an image URL. The method includes receiving a request for the image identified by the image URL and a unique user cookie from the user. The method includes if the identifying data has been previously received, determining a unique user identifier associated with the user from the identifying data. The method includes if the identifying data has not been previously received, determining the unique user identifier associated with the user from the unique user cookie, and associating the identifying information with the unique user identifier.

### CROSS REFERENCE TO RELATED APPLICATIONS

This application claims priority to provisional application No. 60/998,043 entitled “SYSTEM AND METHOD FOR TARGETING THE DELIVERY OF INVENTORIED CONTENT OVER MOBILE NETWORKS TO UNIQUELY IDENTIFIED USERS”, filed Oct. 5, 2007, and which is incorporated herein by reference.

### FIELD OF THE INVENTION

This invention relates to the delivery of inventoried content over mobile networks, and particularly to targeting the delivery of advertisements to uniquely identified users of mobile devices.

### BACKGROUND

“Inventoried content” refers to components of multimedia content that may be requested by network-based publishers and incorporated into larger works displayed on mobile communication devices; the access and display of such inventoried content may be tracked in order to perform related accounting functions. Advertisements are an example of inventoried content that may be incorporated by network-based publishers into larger works that are rendered on end users' mobile devices, mobile phones, or personal digital assistants. An inventoried content delivery service (ICDS) refers to an entity or service organized to maintain an inventory of content received from advertisers and deliver such advertisements to publishers for display to end users.

It is advantageous to an ICDS to be able to identify end users uniquely or individually. For instance, an advertisement may be targeted to a specific subset of end users, such as, by way of example, users that are: (i) located in a given geographic region; (ii) receiving content from a given publisher; (iii) accessing their mobile devices during a given time period; or (iv) using a particular make and model of communication device. As another example, advertisers or publishers may place limits on the number of instances (“impressions”) of an advertisement that may be displayed to a user during a given time period, beyond which the advertiser will not pay for the delivery of additional impressions to the end user; such limits may vary for different categories of users. Click-through rates may be also be affected negatively by excessive advertisement impressions to particular users. As another example, an ICDS may wish to identify end users in order to build a behavioral profile of such users, which may be utilized, by way of example, to offer market research to advertisers and publishers; or to target advertisements or other inventoried content to specific individuals for groups of individuals.

Under the prior art, an ICDS may attempt to identify individual users uniquely by capturing one or more hypertext transfer protocol (http) headers sent from a user device, carrier gateway or other intermediary (such as a transcoding service) to a publisher; such headers may then been forwarded by the publisher along with an advertisement request to the ICDS. However, the success rates of such techniques may vary highly with the mobile device and carrier gateway, and such techniques may only identify a maximum of up to or about sixty percent of end users. Thus, there is a need for content targeting techniques with higher rates of success.

### BRIEF DESCRIPTION OF DRAWINGS

FIG. 1 illustrates an example system for uniquely identifying users on a mobile network.

FIG. 2 illustrates an example timing diagram for uniquely identifying users on a mobile network.

FIG. 3 illustrates an example mobile device accessible by a user to be uniquely identified.

FIG. 4 illustrates an example procedure for uniquely identifying users on a mobile network.

FIG. 5A illustrates an example data structure for storing unique user identifiers.

FIG. 5B illustrates an example data structure entry for storing unique user identifiers.

### DETAILED DESCRIPTION

### 1. Overview

A system and method are provided for uniquely identifying end users on one or more mobile networks in order to optimize delivery of inventoried content to such users. Embodiments of the invention include systems and methods for targeting online advertisements to specified end users or groups of end users, as well as for performing market research on the responses of identified users to particular advertisements (for example, by tracking impressions and clicks). Such research may be utilized, by way of example, to optimize the efficiency and specificity with which advertisement inventory is allocated to end users.

As an illustrative, non-limiting examples, data associated with a unique user under embodiments of the invention can include: the mobile network sites of publishers that are visited by such user on a given day; and advertisements that the end user has interacted with on the given day (by, for example, clicking on a hyperlink within the advertisement). By use of such data, an advertisement for a TV show, for example, might be targeted precisely to a user who has visited a mobile site hosted by a publisher associated with the producer of the TV show, and who has interacted recently with advertisements for similar TV shows (as contrasted with ads that are displayed to randomly chosen users).

### 2. Architecture and Operation of System

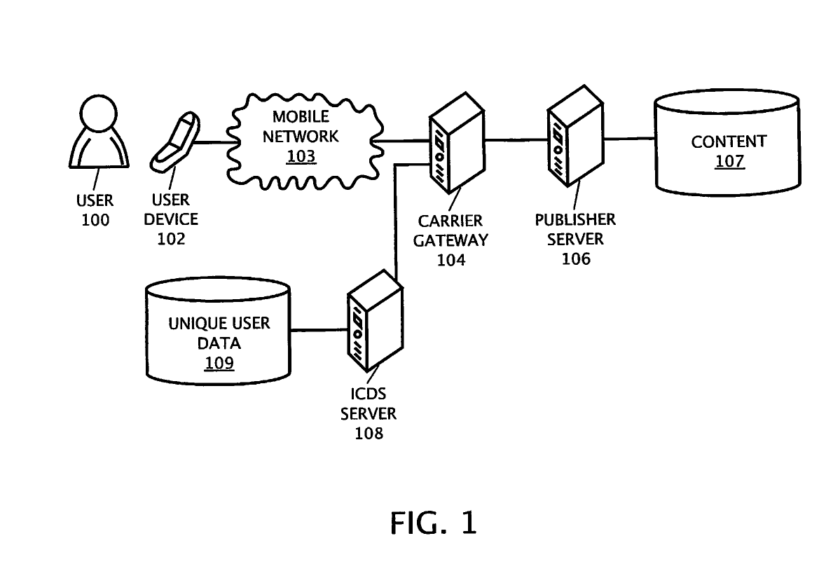

FIG. 1 schematically illustrates an example of a system for uniquely identifying users on a mobile network in accordance with embodiments of the invention. The system includes a communication device 102 on a mobile network and associated with a user 100, such as a mobile device or a mobile phone. The system includes a gateway 104 of a mobile service carrier. The system further includes one or more server(s) of a publisher 106 providing content for display to users on the mobile network 103, as well as one or more server(s) for the ICDS 108.

In embodiments of the invention, the components of this system may interact as follows. A user 100 of a mobile phone 102 accesses, via the carrier gateway 104, a site on a server 106 of a publisher (such as, by way of example, the website “ESPN.com”, of ESPN, Inc., Bristol, Conn.) that is operational to serve content 107, such as, by way of example, web-based content, to the end users; in embodiments of the invention, such servers may be operated on behalf of the publisher by, for example, a content delivery service that caches, hosts, and/or delivers the publisher's content to end users. In embodiments of the invention, the publisher's server(s) 106 (or, in embodiments of the invention, those of the content delivery service) creates a token that is uniquely associated with the user at phone 102. A “token” comprises identifying data such as, by way of example but not limitation, a user identification number (“userid”) in a publisher database, or a session ID (a number assigned to a window through which the user interacts with the publisher site via the mobile device). The publisher may use any unique part of the context of its interaction or state with the end user to generate a token, including, but not limited to, the session id, the encrypted session id, a cookie id; other such examples shall be apparent to those skilled in the art.

In embodiments of the invention, identifying information that is personal or private to the user may be encrypted to in order protect the user's privacy, so that the user may be individually recognized only through his or her interactions with the publisher, but will remain otherwise anonymous in the system. As an illustrative, non-limiting example, a userid based on an end user's name may be represented as a unique string of random digits, so that the user's interactions with the publisher will be associated with those digits, but the user's name cannot be readily deciphered or decoded. Other methods of identifying user interactions uniquely while preserving anonymity of the users shall be apparent to those skilled in the art.

The publisher's server 106 passes to an ICDS server 108 a request for an advertisement to be provided to the user's phone 102 from the ICDS's inventory. The publisher includes the token that it has assigned to that user along with the advertisement request. As stated above, the token may be any representation in the publisher/user context that is unique to the user, including, but not limited to, a user identifier, a session identifier, or an encrypted session id; other examples shall be apparent to those skilled in the art.

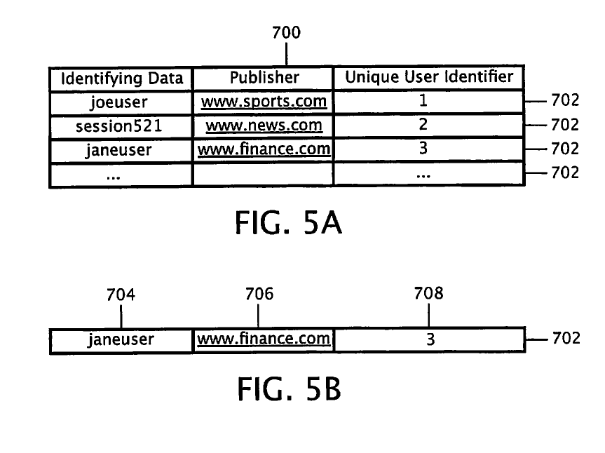

An ICDS server 108 checks one or more databases 109 to see whether the token is recognized, i.e., whether the token has already been associated with a user in the database(s). Examples of data structures that may be used to store unique user identifications and associated user data are depicted in FIGS. 5A and 5B.

The ICDS server 108 thereafter prepares a response to the advertisement request. In embodiments of the invention, the advertisement response includes an image uniform resource locator address (URL) that is encoded with the token and that points to a network domain hosted by ICDS server 108. In embodiments, the advertisement response includes a tracking image, such as a tracking pixel, the URL of which contains a reference to the token. In embodiments, the image URL may be associated with an advertisement in the ICDS database(s).

When the display that is to include the requested advertisement is rendered in the browser of the end user device (which may, for example, constitute a mobile phone) 102, an image request is relayed from the mobile device 102 to the ICDS server 108 via the carrier gateway 104. Along with the image request, the mobile device 102 returns to the server 108 (via the gateway 104) any cookies, or bits of textual information originating from the ICDS's domain that have been written into the memory of the mobile device 102.

The ICDS domain server 108 determines whether the cookies received from the mobile device 102 include a cookie that uniquely identifies the user (a “unique user cookie”). If so, then the unique user cookie is associated with the token received from server 106, and stored for inclusion in responses to future image requests. Thus, the unique user cookie accumulates associations with tokens created by publishers with which the user has interacted, so that the ICDS develops a profile of the unique user's activity on the mobile network. The presence of the unique user cookie in subsequent advertisement requests originating from the phone 102 enables the ICDS to recognize the unique user in future actions, even if those actions involve new sessions, different publishers, and/or occur on different dates. The ICDS is able to recognize the mobile device 102 uniquely, until its unique user cookie is removed from the mobile device 102.

If no unique user cookie is received by server 108 from the mobile device 102, then the server 108 creates a new unique user cookie, and associates it with the token received from server 106. Thereafter, additional tokens may be associated with the new unique user cookie, as discussed above.

The ICDS domain server 108 sends an image response associated with the image URL to the publisher 106, which forwards the image to the phone 102 via the gateway 104. In embodiments of the invention, the image may or may not be visible to the user.

### 3. Processes for Generating and Identifying Unique User IDs

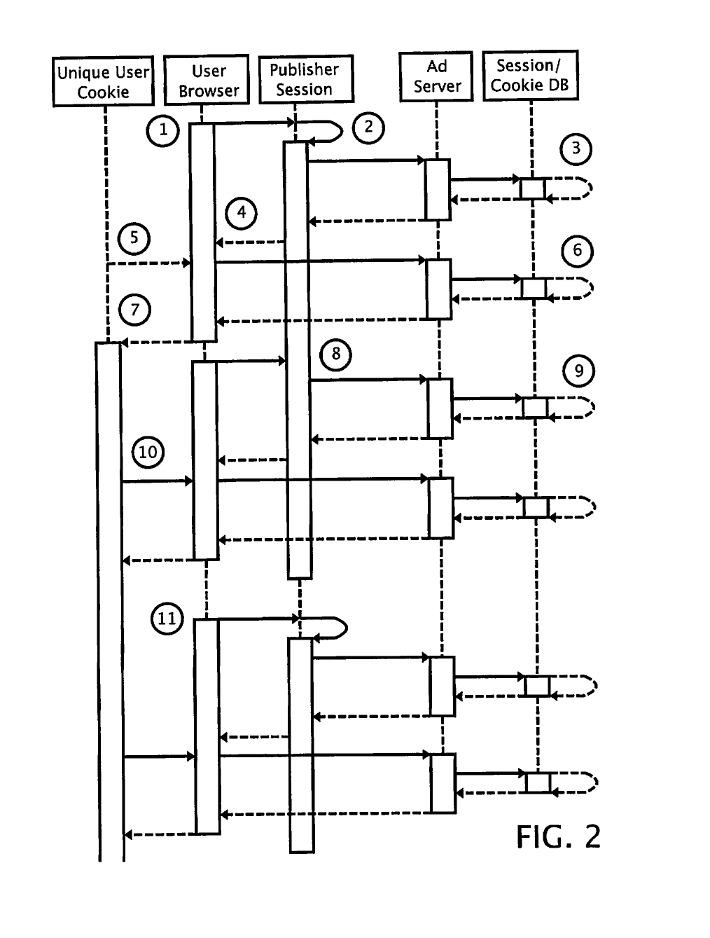

FIG. 2 illustrates an example timing diagram for uniquely identifying users on a mobile network in accordance with embodiments of the invention. At step 1a user who has not been uniquely identified by the ICDS visits a publisher's site on a mobile network.

At step 2, the publisher's site creates a session for the user, and passes the unique session id associated with the session to the ICDS in an advertisement request. As an example, the user can be required to enter a username/password pair to access the publisher's site. As an alternative example, a unique session identifier can be generated by the publisher's site for each new user session.

At step 3, the ICDS searches its session/cookie database for a unique user identifier associated with the user based on the session id, and fails to find such an identifier.

At step 4, an advertisement containing a tracking pixel that is encoded with the session id (or an encrypted representation of the session ID) is returned to the user.

At step 5, no unique user cookie is present in an image request from the user to the ICDS's .com domain.

At step 6, the ICDS creates a new unique user identifier to be associated with a new unique user cookie, and maps the session id to the unique user identifier.

At step 7, the cookie with the unique user identifier is set on the ICDS's.com domain.

Verification that the ICDS has uniquely identified the user may be performed as follows. At step 8, another advertisement request from the user, using the same session id, is sent to the ICDS's .com domain. For example, the second advertisement request from the user can be generated by a second request for content at the publisher's server.

At step 9, the ICDS searches its session/cookie database for the unique user identifier associated with the user based on the session id, and finds the identifier.

At step 10, the ICDS checks the image request for the unique user cookie and finds it, confirming that the session id and cookie have been mapped to each other in the ICDS's session/cookie database.

Thus, at step 11, when the user visits a different publisher mobile network site, or visits the same site with a different session id (i.e., in a new window), the ICDS can recognize the user via the cookie that it has uniquely associated with the user.

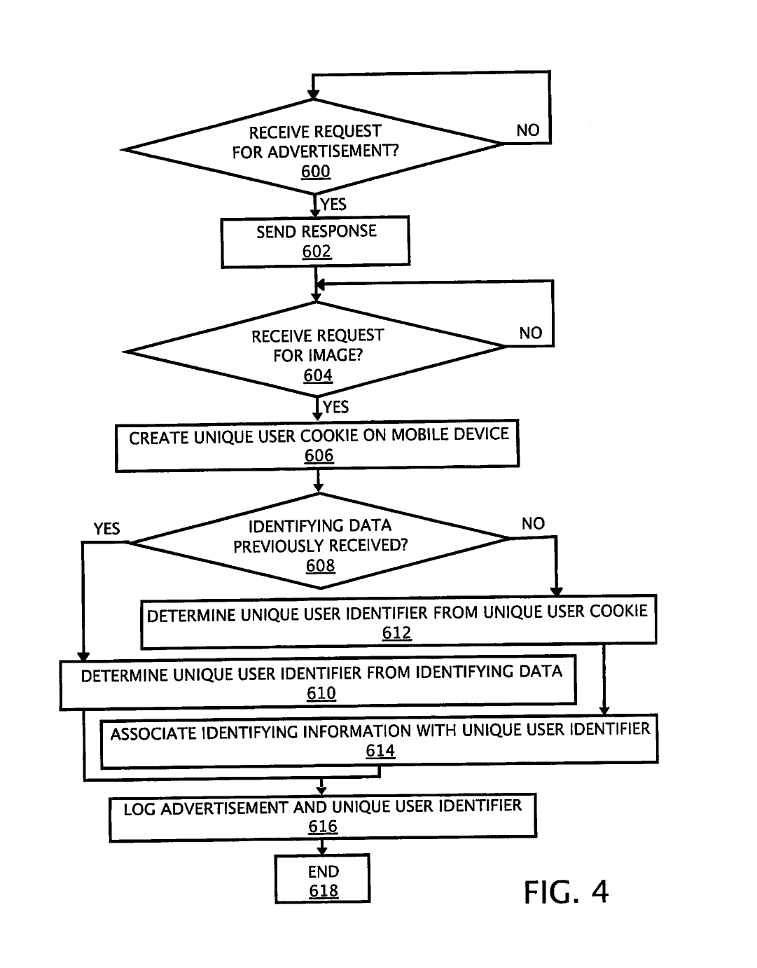

The flowchart in FIG. 4 also illustrates an example procedure that may be executed on an ICDS server for uniquely identifying users on a mobile network. The server checks 600 to see if a request for an advertisement has been received from a publisher. The request includes an identifying data uniquely associated with a user. The identifying data can be a user identifier or a session identifier as discussed above. In embodiments, the identifying data can be encrypted or randomized to protect the user's privacy. If a request for an advertisement has been received, the server proceeds to 602. If no request has been received, the server waits 600.

In response to a publisher request, the server sends a response to the publisher 602. The response includes the requested advertisement and an image URL. The image URL can be an address associated with the server's domain. The image can be any multimedia file, such as, by way of example but not limitation, a tracking pixel.

In 604, the server checks whether a request for the image identified by the image URL has been received. The request can be received along with a unique user cookie. The unique user cookie and the image URL can be associated with the server's domain, allowing the mobile device to transmit it to the server.

If the request for the image has been received, the server can transmit the image to the mobile device and proceed to 606. If no request is received, the server waits at 604.

In 606, the server optionally creates a unique user cookie on the mobile device. For example, the unique user cookie can be a small text file stored in a memory of the mobile device as discussed above.

In 608, the server tests whether the identifying data of 600 has been previously received by the server. For example, the server can access a database of previously received identifying data. If the identifying data is found within the database, the server determines it has been previously received.

If the identifying data has been previously received, the server proceeds to 610. If the identifying data has not been previously received, the server proceeds to 612.

In 610, the server determines a unique user identifier from the identifying data. For example, the server can access a database associating received identifying data with unique user identifiers.

In 612, the server can determine a unique user identifier from the unique user cookie received in 604 or optionally created in 606.

In 614, the server can associate the identifying information with the unique user identifier. For example, this allows the server to uniquely identify the user from the identifying information the next time an advertisement is transmitted to the user.

In 616, the server can log the advertisement and the unique user identifier in an accessible memory. In addition, other information can be logged, such as user actions to the advertisement (click or impression), a date and time of transmission, etc. Upon completion of execution, the server can exit the procedure. 618 or return to initial state to receive additional requests from publishers 600. In embodiments of the invention, the foregoing procedures operate on multiple threads on one or more ICDS servers, in order to serve multiple end user devices and publishers concurrently. Some such embodiments may include locking mechanisms to ensure currency of the one or more databases storing the unique user id and token associations, as shall be apparent to those skilled in the art.

### 4. Data Structures and Persistent Storage for User Identifying Information

FIG. 5A illustrates an example data structure for storing unique user identifiers. A unique user information can be stored in a data structure 700 on a storage medium accessible to an ICDS, which may take the form of attached secondary storage, Storage Area Networking servers, network attached storage, non-volatile main memory, or other alternative storage systems allowing real-time search and retrieval as shall be apparent to those skilled in the art. The data structure 700 includes a set of records 702, each record 702 representing an identifying data used by a publisher.

It will be appreciated that the data structure 700 can be stored in a variety of ways. For example, it can be stored as a tab delimited or comma delimited flat file, in a relational database, in a proprietary file format, or another storage method accessible to a server. Different storage formats will provide different advantages for different applications, as will be appreciated by those skilled in the art.

FIG. 5B illustrates an example data structure entry for storing unique user identifiers. Each record 702 represent an identifying data used by a publisher and associated with a unique user identifier. Each record 702 can contain a variety of data, such as an identifying data 704. The identifying data 704 can be a unique alphanumeric sequence of characters used to identify the user at a publisher, as discussed above.

The record 702 can also include publisher 706 issuing the identifying data 704. For example, each publisher can utilize its own identifying data, and in such embodiments, a publisher/identifying data pair may be utilized to identify a uniquely user session.

In embodiments, the record 702 may include a unique user identifier 708. The unique user identifier 708 may be a unique alphanumeric sequence of characters and used to uniquely identify a user at an ICDS server, as discussed above. It will be appreciated that any amount and any type of metadata can be associated with user.

### 5. Architecture of End User Device

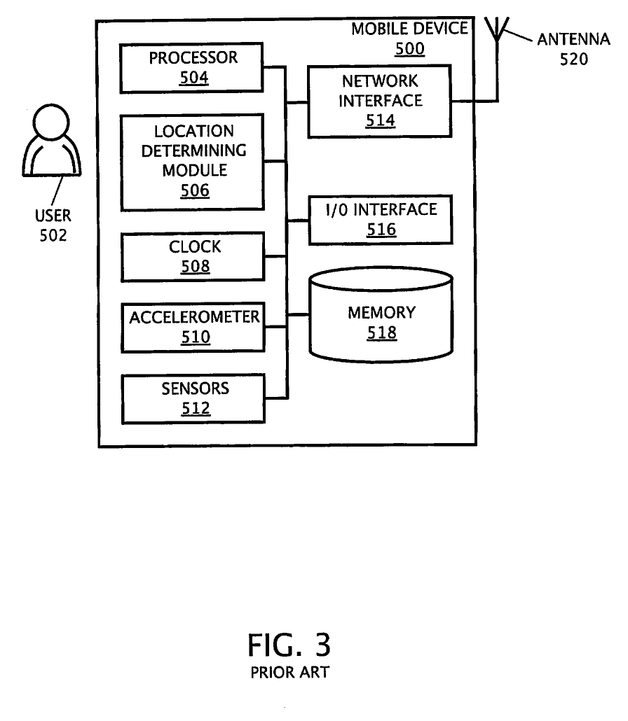

Example architectures and features of the end user access device 102 are discussed below. In embodiments, the end user devise is a mobile device schematically illustrated in FIG. 3. The mobile device 500 can include a processor 504, which may be a general purpose processor configured to execute computer-readable instructions operating the mobile device 500 and associated peripherals. It will be appreciated that any number of processors can be included in the mobile device 500, including specialized processors.

The mobile device 500 can include a location determining module 506. The module 506 can be a GPS receiver module configured to receive GPS signals and calculate a physical location of the mobile device 500 based on the received GPS signals and an internal clock time. The physical location calculation can be optimized by, for example, averaging the GPS signals over time or incorporating a signal from a known nearby location. Alternatively, the module 506 can calculate a physical location by cellular signal triangulation or via short-range wireless network detection. In embodiments of the invention, the location of the end user, as determined by the foregoing features, may be encoded in the token sent to the ICDS server.

The mobile device 500 can include a clock 508 which can provide a local time. In embodiments, the clock 508 can also provide an internal time for use with the GPS module. The clock 508 can be periodically updated from a server in communications with the mobile device 500. In embodiments, a time stamp generated by the clock may be encoded in the token.

In embodiments, the mobile device 500 includes an accelerometer 510. The accelerometer 510 can be configured to detect movements of the mobile device 500 and convert the movement into input signals transmitted to the processor 504. In embodiments, a state of the accelerometer may be included in the token.

The mobile device 500 includes additional sensors 512. Additional sensors can include audio input devices or optical input devices. Audio input devices can include microphones. Optical input devices can include cameras or light sensors. The sensors 512 can be configured to detect appropriate input and convert the input into input signals transmitted to the processor 504. In embodiments, data received from one or more of the foregoing sensors may be included in the token(s).

The mobile device 500 can include a network interface 514. For example, the network interface 514 can communicate with a cellular wireless network, a wired network such as Ethernet, or a short range wireless network such as Bluetooth or Wi-Fi. The mobile device 500 can include multiple network interfaces or a network interface configured to interface with multiple networks. Wireless network interfaces can communicate via an antenna 520.

An Ethernet network allows the mobile device 500 to communicate when plugged in. The mobile device 500 can be assigned an IP address on the wired network. A short-range wireless network can be a Wi-Fi, Wi-Bree or Bluetooth network. Other alternative mobile data protocols that may be supported by the end user device shall be apparent to those skilled in the art.

The mobile device 500 can include an input/output interface 516. The interface 516 can receive user inputs from an input device and convert the user inputs into user commands. For example, input devices can include a touch screen display, a keypad, a microphone, an optical device, a pointer device, a scroll wheel, or other input devices.

The interface 516 can also transmit output to an output device in a form accessible to the user 502. For example, output devices can include a touch screen, a display screen, a speaker, an audio-out jack, an electro-mechanical motor for providing tactile output, or other output devices.

The mobile device 500 can include an antenna 520. The antenna 520 can be configured to transmit and receive wireless signals.

In the example of FIG. 3, a cookie can be stored in the memory 518. The cookie can be a small text file associated with a specific domain and used to identify the mobile device 500 to an ICDS server. For example, the cookie can be a unique user cookie, as discussed herein. In certain embodiments, the end user device may be a stationary computing platform, such as a workstation.

### 6. Conclusion

It will be appreciated to those skilled in the art that the preceding examples and embodiments are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A method for associating a user of a mobile device with content displayed to the user, the method comprising:
receiving a request at one or more content delivery servers for an advertisement from a publisher, wherein the request includes an identifying data uniquely associated with the user;
sending a response to the publisher, wherein the response includes the advertisement and an image URL, wherein the image URL encodes the identifying data and a network domain of the one more content delivery servers;
receiving from the mobile device a request for an image identified by the image URL;
if the image request from the mobile device includes a unique user cookie, then
if the identifying data has been previously received, determining a unique user identifier associated with the user from the identifying data, and
if the identifying data has not been previously received,
determining the unique user identifier associated with the user from the unique user cookie, and
associating the identifying information with the unique user identifier on the one or more databases.

2. The method of claim 1, wherein the image URL and the unique user cookie are associated with a mobile network domain.

3. The method of claim 1, wherein the unique user cookie is stored on the mobile device.

4. The method of claim 3, further comprising:
responsive to detecting the unique user cookie does not exist on the mobile device, creating the unique user cookie on the mobile device and generating a new unique user identifier.

5. The method of claim 1, further comprising:
logging the advertisement and the unique user identifier in an accessible storage.

6. The method of claim 1, wherein the identifying information is at least one of: a user identifier and a session identifier defined by the publisher.

7. The method of claim 6, wherein the identifying information is received in one or more of an encrypted form a hashed form and a randomized form.

8. The method of claim 1, wherein the one or more databases include one or more of a relational database, an object-oriented database, an object-relational database, and a flat file.

9. A system for displaying search results, comprising:
a network interface, and
a processor in communication with the network interface, the processor configured to,
receive a request for an advertisement from a publisher, wherein the request includes an identifying data uniquely associated with a user,
send a response to the publisher, wherein the response includes the advertisement and an image URL,
receive a request for the image identified by the image URL and a unique user cookie from the user,
if the identifying data has been previously received, determine a unique user identifier associated with the user from the identifying data, and
if the identifying data has not been previously received,
determine the unique user identifier associated with the user from the unique user cookie, and
associate the identifying information with the unique user identifier.

10. The system of claim 9, wherein the image URL and the unique user cookie are associated with a mobile network domain.

11. The system of claim 9, wherein the user utilizes a mobile device and the unique user cookie is stored on the mobile device.

12. The system of claim 11, the processor further configured to,
responsive to detecting the unique user cookie does not exist on the mobile device, create the unique user cookie on the mobile device and generating a new unique user identifier.

13. The system of claim 9, the processor further configured to,
log the advertisement and the unique user identifier in an accessible storage.

14. The system of claim 9, wherein the identifying information is at least one of: a user identifier and a session identifier defined by the publisher.

15. The system of claim 14, wherein the identifying information is received in an encrypted form.

16. A physical computer-readable medium including instructions adapted to execute a method for targeting online advertisements, the method comprising:
receiving a request for an advertisement from a publisher, wherein the request includes an identifying data uniquely associated with a user;
sending a response to the publisher, wherein the response includes the advertisement and an image URL;
receiving a request for the image identified by the image URL and a unique user cookie from the user;
if the identifying data has been previously received, determining a unique user identifier associated with the user from the identifying data; and
if the identifying data has not been previously received,
determining the unique user identifier associated with the user from the unique user cookie, and
associating the identifying information with the unique user identifier.

17. The medium of claim 16, wherein the image URL and the unique user cookie are associated with a mobile network domain.

18. The medium of claim 16, wherein the user utilizes a mobile device and the unique user cookie is stored on the mobile device.

19. The medium of claim 16, the method further comprising:
responsive to detecting the unique user cookie does not exist on the mobile device, creating the unique user cookie on the mobile device and generating a new unique user identifier.

20. The medium of claim 16, the method further comprising:
logging the advertisement and the unique user identifier in an accessible storage.

21. The medium of claim 16, wherein the identifying information is received in an encrypted form and is at least one of: a user identifier and a session identifier defined by the publisher
